(19) United States
(12) Patent Application Publication
(10) Pub. No.: US 2023/0186734 A1
(43) Pub. Date: Jun. 15, 2023

(54) SYSTEMS, METHODS, AND MEDIA FOR AN ELECTRONIC SKILL GAMES PLATFORM

(71) Applicant: Burn Ghost Inc., Rushville, NY (US)

(72) Inventors: Jason Krupat, Needham, MA (US); Bret Siarkowski, Marlborough, MA (US); Steve Curran, Rushville, NY (US); Jake Curran, Farmington, NY (US)

(21) Appl. No.: 18/081,188

(22) Filed: Dec. 14, 2022

Related U.S. Application Data
(60) Provisional application No. 63/289,855, filed on Dec. 15, 2021.

(51) Int. Cl. G07F 17/32

(52) U.S. Cl. CPC G07F 17/3295; G07F 17/3255

(57) ABSTRACT

Techniques are provided for an electronic skill based platform. In an embodiment, a gaming platform may receive a predetermined sale price for a product/service from a merchant. The gaming platform may determine a prices for each electronic entry to participate in a skill based game where skill is the predominant factor and chance is not the predominant factor. The gaming platform may generate the skill based game for each participant that purchases an electronic entry. The skill based game may be generated utilizing a clustering technique to determine a skill level for each participant. The gaming platform may determine a score for each participant based on participation in the skill based games. The gaming platform ay determine a winner, wherein the winning participant wins the product/service for a cost that is equal to a selected number of the plurality of electronic entries purchased by the winning participant.

### CROSS-REFERENCE TO RELATED APPLICATIONS

The present application claims the benefit of U.S. Provisional Patent Application Ser. No. 63/289,855, which was filed on Dec. 15, 2021, by Jason Krupat et al., for SYSTEMS, METHODS, AND MEDIA FOR AN ELECTRONIC SKILL GAMES PLATFORM, which is hereby incorporated by reference.

### BACKGROUND

With certain conventional e-commerce systems, a seller, i.e., a merchant, may offer a product for sale at a predetermined sale price. Typically, interested buyers may purchase the product/service if, for example, the offer price equals the predetermined sale price, the offer price among all offer prices is the highest price, the offer price among all offer prices is the closest price to the predetermined sale price, or if the merchant expressly accepts the offer price even when it does not meet the predetermined sale price. With these conventional e-commerce systems, the success of the e-commerce sale is typically dependent upon the number of potential buyers who believe that the product/service is worth at least the predetermined sale price. For example, if a large number of buyers believe that the product/service is worth at least the predetermined sale price, the merchant is likely to receive a larger number of offers, which in turn increases the likelihood of the e-commerce sale. However, if buyers believe the product/service is overpriced, the merchant is less likely to receive offers, which in turn decreases the likelihood of the e-commerce sale. The above described is a technical problem, encountered by conventional e-commerce systems, that stifles e-commerce sales.

Moreover, certain conventional gaming systems typically require that competing participants participate in the same game, e.g., answer the same questions or perform the same tasks, such that the computed scores have a meaningful relationship to each other and can be compared to determine one or more winners. However, such gaming systems have certain drawbacks. For example, and because participants have to participate in the same game, the questions/tasks are typically preconfigured and grouped together. This limits the number of games that the gaming systems can offer its participants, which in turn worsens the user experience since participants may experience repeat questions/tasks. Additionally, participants who have more experience, e.g., participated in more games, can learn/memorize the questions/tasks that may be repeated, which can provide an unlevel playing field and give some participants an unfair advantage over other participants. The feature of providing the same online game to competing participants is a technical problem/limitation that is encountered with conventional gaming systems.

Certain gaming systems that generate and provide chance based games, e.g., games that predominately rely on chance and do not predominately rely on skill, are typically expensive in terms of time and computing resources due to compliance requirements. As an example, consider an electronic slot machine where a participant may pay a fee to initiate and rotate a round of three virtual reels that are marked with varying symbols, e.g., fruits—cherries, plums, oranges, lemons, and watermelons. With this electronic slot machine, the payout to the participant may depend on how many of the symbols line up when the virtual reels come to rest. Such types of electronic slot machines typically utilize a pseudo random number generation (RNG) technique to randomize the resting point for each of the three virtual reels.

Typically, electronic slot machines are required to comply with a return to player (RTP) requirement that may be set by one or more governing agencies. An RTP requirement may be a percentage of all wagered money the electronic slot machine will pay back to participants over time. For example, if a participant makes one hundred $1 bets at a slot machine having an RTP of 92%, the expectation is that the participant will win back $92, e.g., 92% of the $100 spent at the electronic slot machine is returned to the participant. Typically, a governing agency may require that electronic slot machines have an RTP between 92% and 97%.

To comply with these strict RTP requirements, gaming systems typically perform simulation, i.e., execution, testing on their electronic slot machines before going “live” and offering the electronic slot machines to participants. For example, the conventional gaming systems may simulate performance of its electronic slot machines millions of times to determine the RTP for the electronic slot machines to then determine compliance or non-compliance with the RTP requirement.

The simulation testing may have to be performed periodically to continually ensure compliance. Performing such simulation testing is expensive in terms of computer processing resources. Specifically, the gaming platform has to spend considerable amount of processing resources to perform the simulation testing to determine and prove compliance with the designated RTP requirement. Additionally, conventional gaming platforms may be required to save the simulation data to prove compliance which is expensive in terms of computing storage resources. Specifically, the gaming platform may have to acquire additional storage capabilities, e.g., memory, storage devices, etc., to store the simulation data.

Additionally, conventional gaming systems may generate electronic slot machines for different skill levels. Typically, the gaming platform will have to run the simulation testing and store each of the individual produced results (combination of three symbols produced when the three virtual reels come to reset) such that they can be later classified, e.g., classified as easy, hard, etc. Specifically, a particular produced result may be analyzed with relation to the entirety of the produced results to determine how often the produced result is likely to be received by a participant. A produced result that is more likely to be received may be classified as “easy” and a more modest payout may be provided to the participant when the produced result is received. A produced result that is less likely to be received may be classified as “hard” and a more substantial payout may be provided to the participant when the produced result is received. The classification may then be stored with the individually produced results such that each individually produced result has a corresponding payout. However, such classification and payout technique is expensive in terms of computing processing resources and computing storage resources.

The present invention relates to a gaming platform comprising a processor coupled to a memory. The processor is configured to:
receive a predetermined sale price for a product or service offered by a merchant;
determine a purchase price for each of a plurality of electronic entries wherein the purchase price is based on the predetermined sale price, and wherein the plurality of electronic entries are purchasable by at least two participants to participate in an electronic skill based game to win the product or service;
in response to determining that a threshold number of the plurality of electronic entries are purchased by the at least two participants, generate, on-demand, the electronic skill based game for each the of the at least two participants, wherein when performing the generating the processor further configured to:
   select (1) a plurality of skill based questions to be answered by at least two participants or (2) select a plurality of skill based tasks to be performed by the at least two participants,
      wherein the selecting is performed utilizing a homogenization technique to generate at least two electronic skill based games that includes the plurality of skill based questions or the plurality of skill based tasks, and wherein the at least two electronic skill based games for the at least two participants are different based on the utilization of the homogenization technique;
      where a determined answer to each skill based question and each skill based task is predominately based on skill and not predominately based on chance;
determine a score for each of the at least two participants based on at least a number of the plurality of skill based questions answered correctly by the at least two participants or a number of the plurality of skill based tasks performed correctly by the at least two participants; and
determine one or more winning participants based on a comparison of the scores.
   Optionally, each of electronic skill based games generated for the at least two participants is a same type and includes a plurality of different skill based questions or a plurality of different skill based tasks that are determined to be a same difficulty.
   As another option, the process is further configured to normalize each of the scores determined for the at least two participants utilizing one or more different normalization techniques to perform the comparison of scores.
   Optionally, when normalizing a score of a particular participant, the processor further configured to:
determine an average value and a standard deviation value for a particular skill based game based on a plurality of previous participants scores obtained during a testing phase; and
utilize the score of the particular participant with the average value and the standard deviation value to generate a normalized score for the particular participant.
   As still another option, each of the electronic skill based games generated for the at least two participants is an electronic skill based slot machine that includes a plurality of reels, where each reel is selectable by the participant.
   Optionally, a particular skill based game includes one or more binary questions.
   In some embodiments, the processor is further configured to:
receive an indication, via a client device, a particular answer of yes or no for each of the one or more binary questions.
   The present invention also relates to a method for generating an electronic skill based game. The method comprises:
receiving, at a gaming platform, a predetermined sale price for a product or service offered;
determining, by a processor of the gaming platform, a purchase price for each of a plurality of electronic entries wherein the purchase price is based on the predetermined sale price, and wherein the plurality of electronic entries are purchasable by at least two participants to participate in the electronic skill based game to win the product or service offered;
in response to determining that a threshold number of the plurality of electronic entries are purchased by of the at least two participants, generate, on-demand, the electronic skill based game for each the at least two participants, wherein generating the electronic skill based game comprises:
   generating, utilizing a clustering algorithm, a plurality of cluster each of which includes a plurality of cluster participants that share cluster participant metadata;
   analyzing the cluster participant metadata of each of the plurality of clusters to determine a cluster skill level for each of the plurality of clusters;
   generating a cluster profile for each of the clusters, wherein the cluster profile includes information based on the cluster participant metadata and the determined cluster skill level;
   comparing participant metadata for each of the at least two participants to the cluster profile determined for each of the plurality of clusters;
   in response to performing the comparison, identifying a particular cluster of the plurality of clusters for each of the at least two participants;
   assigning, to each of the at least two participants, a particular difficulty level that corresponds to the cluster skill level of a particular cluster profile of the identified particular cluster; and
   selecting (1) a plurality of skill based questions to be answered by the at least two participants or (2) selecting a plurality of skill based tasks to be performed by the at least two participants, wherein the selected skill based questions or selected skill based tasks have a determined difficulty that corresponds to the particular difficulty level,
      where a determined answer to each skill based question and each skill based task is predominately based on skill and not predominately based on chance;
determining a score for each of the at least two participants based on at least a number of the plurality of skill based questions answered correctly by the at least two participants or a number of the plurality of skill based tasks performed correctly by the at least two participant; and
determining one or more winning participants based on a comparison of the scores determined for the at least two participants.
   In a further development of the method, each of electronic skill based games generated for the at least two participants is a same type and includes a plurality of different skill based questions or a plurality of different skill based tasks that are determined to be a same difficulty.
   Optionally, the method further comprises normalizing each of the scores determined for the at least two participants utilizing one or more different normalization techniques to perform the comparison of scores, whereby as a further option, when normalizing a score of a particular participant, the method further comprises:
determining an average value and a standard deviation value for a particular skill based game based on a plurality of previous participants scores obtained during a testing phase; and
utilizing the score of the particular participant with the average value and the standard deviation value to generate a normalized score for the particular participant.
   Optionally, each of the electronic skill based games generated for the at least two participants is an electronic skill based slot machine that includes a plurality of reels, where each reel is selectable by the participant.
   As another option, the method further comprises:
identify one or more first attributes of a particular participant or one or more second attributes of a particular skill based game that the particular participant participated in;
determining a topic of interest of the particular participant that corresponds to the one or more first attributes or the one or more second attributes; and
displaying one or more advertisements, related to the topic of interest, on a particular computing device operated by the particular participant.
   Optionally, a particular skill based game includes one or more binary questions, and the method further comprises:
receiving an indication, via a client device, a particular answer of yes or no for each of the one or more binary questions.
   The present invention also relates to one or more non-transitory computer-readable media, having stored thereon instructions that when executed by a computing device, cause the computing device to perform operations comprising:
receiving a predetermined sale price for a product or service offered;
determining a purchase price for each of a plurality of electronic entries wherein the purchase price is based on the predetermined sale price, and wherein the plurality of electronic entries are purchasable by at least two participants to participate in the electronic skill based game to win the product or service offered;
in response to determining that a threshold number of the plurality of electronic entries are purchased by of the at least two participants, generate, on-demand, the electronic skill based game for each the at least two participants, wherein generating the electronic skill based game comprises:
   generating, utilizing a clustering algorithm, a plurality of cluster each of which includes a plurality of cluster participants that share cluster participant metadata;
   analyzing the cluster participant metadata of each of the plurality of clusters to determine a cluster skill level for each of the plurality of clusters;
   generating a cluster profile for each of the clusters, wherein the cluster profile includes information based on the cluster participant metadata and the determined cluster skill level;
   comparing participant metadata for each of the at least two participants to the cluster profile determined for each of the plurality of clusters;
   in response to performing the comparison, identifying a particular cluster of the plurality of clusters for each of the at least two participants;
   assigning, to each of the at least two participants, a particular difficulty level that corresponds to the cluster skill level of a particular cluster profile of the identified particular cluster; and
   selecting (1) a plurality of skill based questions to be answered by the at least two participants or (2) selecting a plurality of skill based tasks to be performed by the at least two participants, wherein the selected skill based questions or selected skill based tasks have a determined difficulty that corresponds to the particular difficulty level,
      where a determined answer to each skill based question and each skill based task is predominately based on skill and not predominately based on chance;
determining a score for each of the at least two participants based on at least a number of the plurality of skill based questions answered correctly by the at least two participants or a number of the plurality of skill based tasks performed correctly by the at least two participant; and
determining one or more winning participants based on a comparison of the scores determined for the at least two participants.
   As an option, each of electronic skill based games generated for the at least two participants is a same type and includes a plurality of different skill based questions or a plurality of different skill based tasks that are determined to be a same difficulty.
   As another option, the instruction further cause the computing device to perform operations comprising normalizing each of the scores determined for the at least two participants utilizing one or more different normalization techniques to perform the comparison of scores
   As still another option, when normalizing a score of a particular participant, the computing device further performs operations comprising:
determining an average value and a standard deviation value for a particular skill based game based on a plurality of previous participants scores obtained during a testing phase; and
utilizing the score of the particular participant with the average value and the standard deviation value to generate a normalized score for the particular participant.
   Optionally, each of the electronic skill based games generated for the at least two participants is an electronic skill based slot machine that includes a plurality of reels, where each reel is selectable by the participant.
   Optionally, a particular skill based game includes one or more binary questions.
   As another option, the computing device further performs operations comprising:
identifying a selected participant who has participated in one or more particular skilled based games over a predetermined time period;
determining an aggregate score the selected participant based on participation in the one or more particular skilled based games, wherein the aggregate score is utilized to determine a ranking for the participant;
selecting one or more characteristics that are shared between the selected participant and one or more other participants, wherein the selecting is based on a determination that the ranking for the selected participant, in relation to other rankings of the one or more other participants, is equal to or better than a baseline ranking; and generating a dynamic leaderboard that ranks the selected participant with the plurality of other participants based on the raking and the other rankings, wherein the dynamic leaderboard graphical or textually displays the ranking of the selected participant being equal to or better than the baseline ranking.

### BRIEF DESCRIPTION OF THE DRAWINGS

The description below refers to the accompanying drawings, of which:

FIG. 1 is a high-level block diagram of an example architecture for utilizing a online gaming platform that facilities online transactions according to the one or more embodiments described herein;

FIG. 2 is a diagram illustrating an exemplary access data structure according to one or more embodiments as described herein;

FIG. 3 is a diagram illustrating an exemplary skill based electronic slot machine according to the one or more embodiments as described herein;

FIG. 4 is a diagram illustrating an exemplary different skill based electronic game 400 according to the one or more embodiments as described herein;

FIG. 5 is a diagram illustrating an exemplary skill based task according to the one or more embodiments as described herein; and

FIG. 6 is an example flow diagram illustrating a series of steps that may be performed according to the one or more embodiments described herein.

### DETAILED DESCRIPTION OF AN ILLUSTRATIVE EMBODIMENT

Techniques are provided for an electronic skill games platform that overcomes the above described deficiencies. Briefly, the one or more embodiments described herein provide one or more technical solutions to the technical problem, as described above, where the success of an online transaction for a merchant product/service is dependent on whether an offer price is consistent with consumers' value of the product/service. Specifically, and according to the one or more embodiments as described herein, a gaming platform (e.g., a gaming module of the gaming platform) may receive a predetermined sale price for a product/service from a merchant. In alternative embodiment, the predetermine sale price may be predefined or may be determined in any of a variety of different ways. For example, artificial intelligence may evaluate the characteristics of the product/service to determine a fair market price for the product/service. The gaming platform may offer, for online purchase to potential buyers, is a plurality of electronic entries to participate in a skill based game.

In an embodiment, the skill based game, e.g., an online game where skill is the predominant factor and chance is not the predominant factor, includes a plurality of skill based questions to be answered by participants and/or skill based tasks to be performed by the participants. Alternatively, the skill based game may include a single skill based question or a single skill based task to be performed by participants. In an implementation, each entry costs a fraction of the predetermined sale price of the product/service, and the total value of the entries is equal to or greater than the predetermined sale price.

In an embodiment, each participant that has purchased one or more electronic entries may participate in the skill based game a total number of times that equals the total number of purchased electronic entries. The gaming platform may determine a score for each participant of the skill based game and then determine one or more winners based on the determined scores as will be described in further detail below. The one or more winners, who may have only paid a single entry fee, may win the product/service, or a portion of the product/service, and the merchant may receive the proceeds from the sale of the total number of electronic entries which is equal to or greater than the predetermined sale price.

Advantageously, the success of the e-commerce sale is not dependent upon the number of potential buyers who believe that the product/service is worth at least the predetermined sale price set by the seller. Instead, the success of the e-commerce sale is dependent upon the number of potential buyers who believe that the product/service is worth the electronic entry fee for the skill based game. Stated another way, the participants who do not win the skill based game subsidize the majority of the predetermined sale price that is provided to the merchant by way of the purchase of the electronic entries. Because the entry fee may be a fraction of the cost of the predetermined sale price, a larger number of potential buyers are likely to be interested, which in turn increases the likelihood of a successful e-commerce sale.

By offering entries to a skill based game to purchase a product/service as described herein, the one or more embodiments described herein provide a technical solution to the above described technical problem. Based on the technical solution as described herein, a merchant is able to sell the product/service for the predetermined sale price set by the merchant, and at the same time the buyer is able to obtain the product/service for a fraction of the predetermined sale price, e.g., the cost of an entry fee to participate in the skill based game. As such, the technical solution as described herein facilitates a larger number of successful e-commerce sales that is simultaneously advantageous to both online merchants and buyers.

Moreover, the one or more embodiments described herein provide a technical solution to the technical problem where competing participants are required to participate in the same game (e.g., answer the same questions or perform the same tasks) such that the computed scores have a meaningful relationship to each other and can be compared to determine one or more winners. Specifically, the one or more embodiments as described herein homogenize a skill based games and/or normalize computed scores as described in further detail below such that competing participants do not have to participate in the same game.

In an embodiment, a participant's skill level may be determined prior to the participant's participation in the skill based game. Specifically, the one or more embodiments as described herein may utilize a clustering algorithm to generate a plurality of clusters. In an embodiment, any of a variety of different clustering algorithms may be utilized to generate the plurality of clusters. Each cluster may include a plurality of participants, e.g., previous participants, who share similar participant metadata. Such metadata may include, but is not limited to, historical data indicating the questions/tasks that the participant previously answered/performed, and information indicating whether the participant answered the question correctly and/or whether the participant successfully performed the task, to what degree the participant successfully performed the task, etc.

Based on the clustering, each cluster may have an assigned skill level. Participant metadata for a new participant may be compared with a cluster profile that is generated for each of a plurality of clusters as will be described in further detail below. The one or more embodiments as described herein may determine that the participant metadata for the new participant best matches or correlates with a cluster profile of a particular cluster. Based on the determination, the new participant may be assigned a skill level of the cluster. Because the participant metadata is only compared to the profiles of the clusters instead of the individual user profiles of previous participants, the one or more embodiments as described herein conserve processing resources of the computing device when compared to conventional techniques that may compare the participant metadata to each of the individual user profiles.

Further, by homogenizing the skill based games and/or normalizing each computed score, the scores can be compared to determine one or more winners even though the scores are computed for different skill based games, e.g., a plurality of skill based games that are the same type but each of which may include different skill based questions/tasks.

Because scores computed for different skill based games can be compared based on homogenizing the skill based games and/or normalizing the scores, the one or more embodiments described herein provide parity, i.e., a level playing field, to competing participants who may participate in different skill based games for the product/service. Therefore, homogenization of the skill based games and/or normalization of the scores allows for any combination, i.e., a limitless combination, of different questions/tasks to be utilized in a skill based game such that participants do not, for example, receive the same questions in multiple, e.g., subsequent, skill based games. As such, the participant experience is improved when compared to conventional online gaming systems that may, for example, utilize the same questions/tasks (e.g., repeated questions/tasks) in multiple games. Further, and because a unique set of questions/tasks can be generated for any skill based game, the one or more embodiments described herein deter participants from learning/memorizing questions/tasks to gain an unfair advantage over other participants.

Moreover, the one or more embodiments described herein overcome the deficiencies associated with chance based electronic games, e.g., chance based electronic slot machines. Specifically, the one or more embodiments as described herein utilize a skill based electronic slot machine that predominately relies on skill, e.g., a skill based electronic slot machine that does not predominately rely on chance. The determination that a game predominately relies on skill and does not predominately rely on chance may be based on one or more laws, regulations, etc. For example, different States within The United States of America may each define, differently or similarly, a skill based game and/or a chance based game. As such, and according to the one or more embodiments described herein, a skill based game may be any electronic game that complies with at least one State's definition of a skill based game and/or does not comply with the at least one State's definition of a chance based game.

In an implementation, a skill based electronic slot machine may be generated, according to the one or more embodiments described herein, to ask a participant to answer a series of skill based questions and/or to perform a series of skill based tasks. For example, the skill based electronic slot machine may select and display three or more different individuals on a computer display, and then request that the participant select the tallest individual of the displayed individuals. Because the tallest individual of the three displayed individuals is a factual based question that does not predominately rely upon chance, this skill based question may be excluded from the definition of a chance based question/game. The skill based electronic slot machine may generate additional and similar skill based questions and/or tasks as part of the single skill based electronic slot machine. In an embodiment, the participant's score may be determined based on the number of correct answers and a total amount of time it takes to answer the questions and/or perform the tasks. In an implementation, all of the questions and/or tasks that make up the skill based electronic slot machine predominately rely on skill. As such, the skill based electronic slot machine is excluded from the definition of a chance based game.

Because the skill based electronic slot machine is excluded from the definition of a chance based game, the skill based electronic slot machine according to the one or more embodiments described herein does not have to strictly comply with particular regulatory requirements, e.g., RTP, that may govern online slot machines that are predominately based on chance. In an embodiment, the electronic skill based slot machine may be assigned an RTP based on a determined difficulty level. For example, if the electronic skill based slot machine, e.g., a skill based question of the electronic skill based slot machine, is determined to have a difficulty of easy, the skill based question may be assigned a particular RTP, e.g., 98% or in a range of 97%-99%.

Advantageously, the one or more embodiments described herein do not need to perform simulation testing and do not need to store simulation results to ensure compliance with the regulatory requirements. Therefore, the gaming platform as described herein conserves processing resources and storage resources when compared to conventional gaming systems that implement predominately chance based games and have to expend high processing and storage resources to perform simulation testing to ensure regulatory compliance. Accordingly, and by implementing the skill based electronic slot machine, the one or more embodiments described herein provide an improvement to a gaming platform, e.g., computer, itself.

Additionally, the one or more embodiments described herein may generate different skill based games for different skill levels utilizing one or more threshold values. For instance, and continuing with the above example of the skill based question with three individuals of different heights, the platform may select three individuals that all have heights that are within different threshold ranges to generate the skill games for different skill levels. For example, let it be assumed that to classify a skill based question as “expert” level, the gaming platform is to select three individuals for display that have heights that are all within 1 inch of each other (e.g., +/−1 inch). As such, the platform may randomly select a first individual for display that is 6′1″. Therefore, and for the expert level, the gaming platform may randomly select an individual for display that has a height that is greater than or equal to 6′0″ and less than or equal to 6′2″ (e.g., +/−1 inch of 6′1″). In this example, let it be assumed that the gaming platform selects an individual for display that is 6′0″. Therefore, the gaming platform may randomly select an individual for display that has a height that is greater than or equal to 6′0″ and less than or equal to 6′1″ such that all three displayed individuals are within 1 inch of each other.

As another example, let it be assumed that to classify a skill based question as “difficult” level, the gaming platform is to select two individuals for display that have heights that are all within 1 inch of each other (e.g., +/−1 inch) and the third individual for display is within 6 inches (+/−6 inches) of the other two individuals. As such, the gaming platform may randomly select a first individual for display that is 6′1″. Therefore, and for the difficult level, the gaming platform may randomly select an individual for display that has a height that is greater than or equal to 6′0″ and less than or equal to 6′2″ (e.g., +/−1 inch of 6′1″). In this example, let it be assumed that the gaming platform selects an individual for display that is 6′0″. The gaming platform may then randomly select a third individual for display that has a height that is greater than or equal to 5′7″ and less than or equal to 6′6″ such that all the third displayed individuals is within 6 inches of the other two displayed individual. Although the examples described is herein utilizes particular criteria and values to define particular skill levels (e.g., expert and difficult), it is expressly contemplated that any of a variety of different criteria and values may be utilized define any of a variety of different skill levels (e.g., expert, difficult, intermediate, easy, etc.) according to the one or more embodiments described herein.

Because the classification according to the one or more embodiments described herein can be done “on the fly” and without having to store the individual combination prior to producing the individual combinations (e.g., three individuals that are within 1 inch of each other), the one or more embodiments described herein conserve computing processing resources and computing storage resources when compared to conventional gaming platforms that may have to, for example, store the individually produced results, analyze the stored results to determine a skill level for each produced result, and then store the determined skill level with the individually produced result. Accordingly, the one or more embodiments described herein provided an improvement to a gaming platform, e.g., computer, itself.

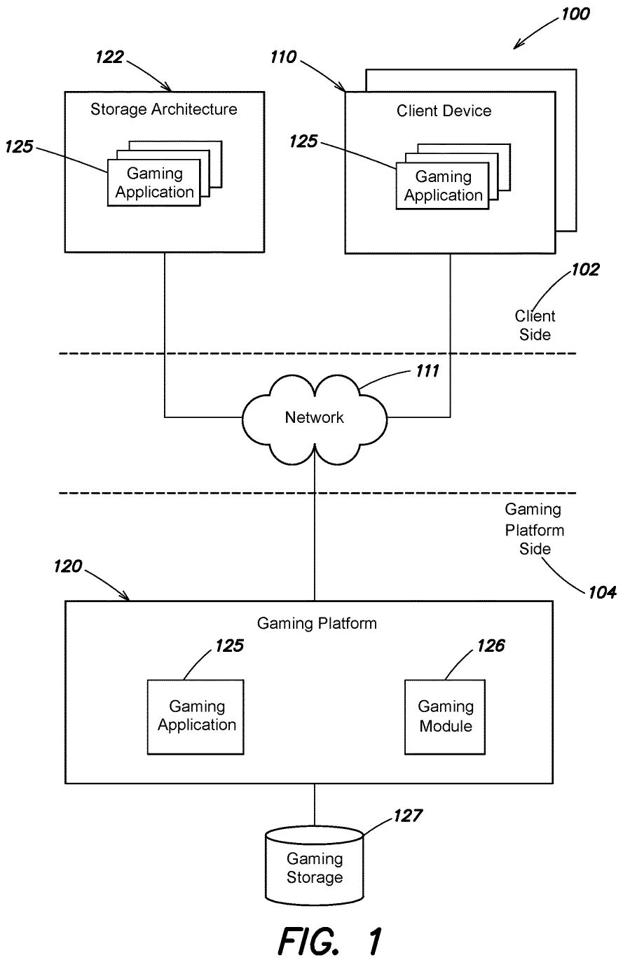

FIG. 1 is a high-level block diagram of an example architecture 100 for utilizing a online gaming platform that facilities online transactions according to the one or more embodiments described herein. The architecture 100 may be divided into a client side 102 and a gaming platform side 104. The client side 102 may include one or more local client devices 110 and storage architecture 122. The gaming platform side 104 may include electronic gaming platform 120 that is remote from the devices of the client side 102 and that is accessible to the end users, e.g., that operate or have access to the client devices 110 and/or storage architecture 122. Each computing device, e.g., one or more is local client devices 110, storage architecture 122, and gaming platform 120 may include processors, memory/storage, a display screen, and other hardware (not shown) for executing software, storing data, and/or displaying information. In an implementation, the gaming platform 120 may be a cloud-based platform, e.g., one or more cloud-based devices.

A local client device 110 may provide a variety of user interfaces and non-processing intensive functions. For example, a local client device 110 may provide a user interface, e.g., a graphical user interface and/or a command line interface, for receiving user input and displaying output according to the one or more embodiments described herein. In an embodiment, the client device 110 may be a server, a workstation, a platform, a mobile device, a network host, or any other type of computing device. The client device 110 may store and gaming application 125. In an implementation, the gaming applications 125 may perform one or more different functions for end users (e.g., participants and merchants) that operate client devices 110. For example, the gaming application 125 may be provided by the gaming platform 120 and installed on client device 110 such that the end user (e.g., participants and merchants) may execute gaming application 125 to (1) participate in one or more skill based games, and/or (2) offer a product/service for a predetermined sale price to facilitate a purchase/sale of the product/service according to the one or more embodiments described herein.

The storage architecture 122 on client side 102 can be any of a variety of different types of storage architectures or systems that provide, over network 111, input criteria to the electronic transaction platform 120. For example, the storage architecture may include, but is not limited to, cloud storage, databases, applications, application program interfaces (APIs), the Internet of Things (IoT) storage, hard disk drives, solid state drives, etc. In an implementation, the storage architecture 122 may store/host gaming application 125 such that client device 110 may access and execute the gaming application 125 to, for example, (1) participate in one or more skill based games, and/or (2) offer a product/service for a predetermined sale price to facilitate a purchase/sale of a product/service according to the one or more embodiments described herein.

The gaming platform 120 may store and execute gaming module 126 that may implement the one or more embodiments described herein. For example, the gaming module 126 may implement a plurality of functions/processes that include, but are not limited to (1) generating one or more skill based games according to the one or more embodiments described herein and as described in further detail below, (2) determining scores for one or more skill based games according to the one or more embodiments described herein and as described in further detail below, and (3) facilitating, executing, and completing one or more online transactions based on participation in one or more skill based games according to the one or more embodiments described herein and as described in further detail below.

Additionally, client device 110 may access and execute the gaming application 125 on gaming platform 120 to, for example, to (1) participate in one or more skill based games, and/or (2) offer a product/service for a predetermined sale price to facilitate a purchase/sale of a product/service according to the one or more embodiments described herein.

The gaming platform 120 may be coupled to gaming storage 127. Gaming storage 127 may be cloud storage, one or more databases, one or more hard disk drives (HDDs), one or more solid state drives (SSDs), etc. In an implementation, the gaming storage 127 may store one or more values and/or data structures that are generated and/or utilized according to the one or more embodiments described herein.

It will be apparent to those skilled in the art that other types of processing elements and memory, including various computer-readable media, may be used to store and execute program instructions pertaining to the embodiments described herein. Also, while the embodiments herein are described in terms of software code, processes, and computer programs (e.g., applications) stored in memory, alternative embodiments also include the code, processes and programs being embodied as logic, components, modules and/or engines consisting of hardware, software, firmware, or combinations thereof.

In an embodiment, a skill based game, generated according to the one or more embodiments described herein, may include one or more skill based tasks/questions that are to be answered/performed by a participant. Specifically, the skill based game may be a skill based electronic slot machine and each “spin” of the electronic skill based slot machine may correspond to a different question/task. In an implementation, a spin may represent a display of a skill based question and a plurality of potential answers/responses to the skill based question. In an implementation, a spin may represent a display of a task to be performed by the participant. As such, different spins of the electronic skill based slot machine may be displayed at different times on, for example, the client device 110.

For example, if the electronic skill based slot machine includes 10 skill based questions/tasks, each spin of the electronic slot machine may correspond to a different question/task of the 10 skill based questions/tasks. For example, and after the participant is has answered/performed the first question/task that is displayed on client device 110, the gaming module 126 may generate and display, on client device 110, a second question/task to be answered/performed by the participant. Subsequently, the gaming module 126 may generate and consecutively display the remaining 8 questions/tasks for the electronic skill based electronic slot machine.

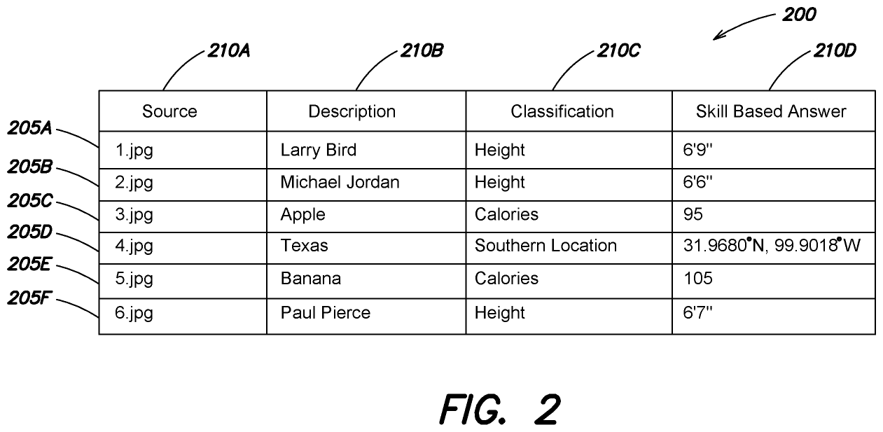

To generate a skill based question/task, the gaming module 126 may generate and access data structure 200 of FIG. 2. FIG. 2 is a diagram illustrating an exemplary access data structure 200 according to one or more embodiments as described herein. In an implementation, any of a variety of different techniques may be utilized to generate data structure 200 of FIG. 2. For example, an authorized user of gaming platform 120 may populate the data structure 200 of FIG. 2. Alternatively, one or more algorithms (e.g., machine learning algorithms) or conditional logic may be utilized to generate and populate data structure 200 of FIG. 2.

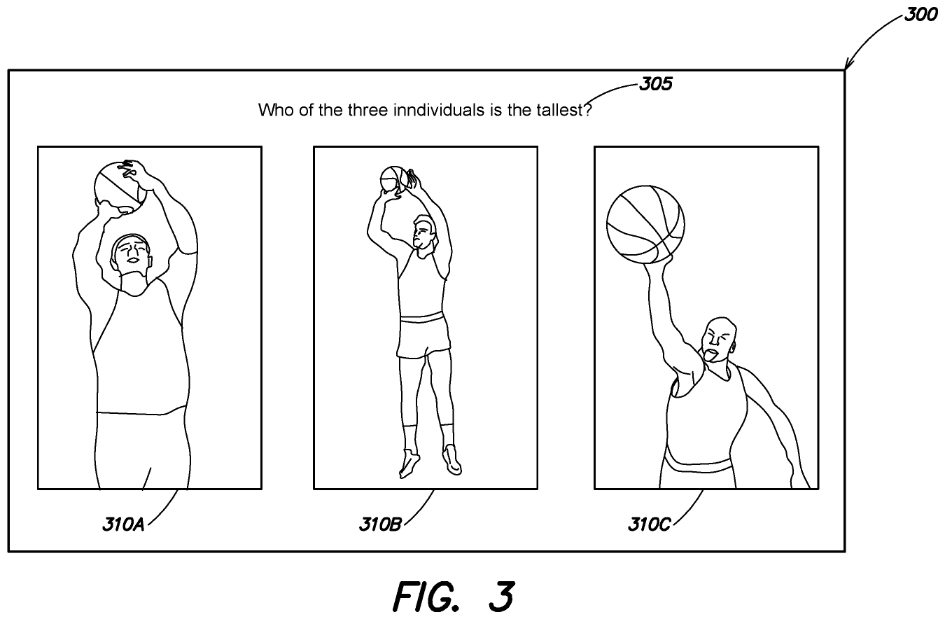

As an example, let it be assumed that the skill based question, for an electronic skill based slot machine, is to ask the participant—“Who of the three individuals is the tallest?”, where the three individuals are displayed on the client device 110 operated by the participant. To generate this height based skill based question, the gaming module 126 may access and utilize data structure 200. Specifically, and because the skill based question to be generated is associated with height, the gaming module 126 may access data structure 200 and may randomly identify an entry with a corresponding classification in classification field 210C that indicates height. In this example, let it be assumed that the gaming module 126 identifies entry 205F that has a classification of height indicated in field 210C. Therefore, and in this example, the gaming module 126 may access the source file, in this case an image of Paul Pierce who is 6′7″, and utilize that image as a first “reel”, i.e., option, of the skill based electronic slot machine. Specifically, and as will be described in further detail below with reference to FIG. 3, an image of Paul Pierce may be displayed on the client device 110 as an optional answer for the skill based question of “Who of the three individuals is the tallest?”

Based on a specified difficulty level, e.g., easy, moderate, hard, expert, etc., the gaming module 126 may select a different entry for the same classification from data structure 200. In an embodiment, the gaming module 126 may determine a skill level for a participant, e.g., a new participant, based on participant metadata of the participant. In an embodiment, the participant metadata may include, but is not limited to, age, sex, geographical location/region, skill based questions previously answered by the participant, whether the participant answered those previous skill based questions correctly or incorrectly, skill based tasks previously performed by the participant, whether the participant successfully performed the previously performed skill based tasks successfully and to what degree the task was performed successfully, etc.

In an embodiment, the gaming module 126 may generate a plurality of clusters based on the analysis of the participant metadata for a plurality of different participants, e.g., previous participants. For example, the gaming module 126 may determine that those participants who answer at least 80% of skill based questions correctly are to form a particular cluster. Alternatively, the gaming module 126 may determine that those participants who are located in the same geographical region, e.g., Northeast of the United States, and who answer at least 80% of skill based questions correctly are to form a particular cluster. Therefore, the gaming module 126 may generate the plurality of is clusters in any of a variety of different ways.

Each of the plurality of clusters may have a corresponding cluster profile. The cluster profile may define, at a high-level, the participants that are included in the cluster. For example, the cluster profile for the above describe cluster may include information indicating that the participants that make up the cluster are from the Northeast of the United States of America and have correctly answered at least 80% of the skill based questions asked to them. The cluster profile for the cluster may also indicate that the participants of the cluster are at a determined skill level of hard. A different cluster profile for a different cluster may indicate that the participants that make up the different cluster are from the Midwest of the United States of America and correctly answered at least 50% of the skill based questions asked to them. The different cluster profile may also indicate that participants of the different cluster are at a determined skill level of medium. In an embodiment, the clusters may be formed/generated based on a predetermined scheduled or on-demand and based on user input. The cluster may be formed/generated at different times since the participant metadata may change over time. For example, a participant's determined skill level may change over time as the participant participates in more skill based games.

After the plurality of clusters are generated, the gaming module 126 may compare the participant metadata of the participant, e.g., new participant, with the cluster profiles to identify one or more matching clusters. In this example, let it be assumed that the customer metadata for the participant indicates that the participant lives in the Northeast of the United States of America and has answered at least 80% of skill based questions correctly. Accordingly, the gaming module 126 may identify the particular cluster as described above. Specifically, and based on the comparisons of the participant metadata and the cluster profiles, the gaming module 126 may determine that the participant, e.g., new participant, correlates best with or substantially matches to the particular cluster. Based on the determination, the gaming module 126 may determine that the participant is assigned a skill level of hard, e.g., the skill level of the identified particular cluster.

Therefore, the one or more embodiments as described herein only have to compare the participant metadata to the cluster profiles. The one or more embodiments as described herein do not have to perform a comparison of the participant metadata with each of the plurality of other individual participants, which may be required by conventional systems. For example, some conventional systems may require that the participant metadata be compared with each other participant to identify the most similar other participant. Conventional systems may use the difficultly level of the most similar participant as the difficulty level for the participant, e.g., new participant.

Therefore, the one or more embodiments as described herein conserve processing resources of the computing system, e.g., gaming platform 120, when compared to conventional systems since processing resources are only required to compare the participant metadata with the cluster profiles.

In an embodiment, the skill based questions may be selected based on determining or identifying the particular cluster. For example, and based on identifying the particular cluster, the gaming module 126 may identify a previous skill based question that has been asked to a participant included in the particular cluster. The gaming module 126 may then utilize the previous skill based question, identified from the cluster, as the question that is to be asked to the participant, e.g., new participant.

In this example, the specified difficulty level is hard. Let it be assumed that for the level of hard all displayed individuals, i.e., potential options for the participant to select, are within a three inch height range. Thus, in this example, the gaming module 126 may identify a different entry in data structure 200 where the classification in classification field 210C indicates height and the skill based answer in the skill based answer field 210D indicates a height that is within (+/−) three inches of the height indicated in skill based answer field 210D for entry 205F that was already selected.

In this example, let it be assumed that the gaming module 126 selects entry 205A since the height of 6′9″ as indicated in skill based answer field 210D is two inches greater than the height of 6′7″ indicated in skill based answer field 210D of entry 205F. Therefore, the gaming module 126 may access the source file, in this case an image of Larry Bird who is 6′9″, and utilize that image as a second “reel”, i.e., option, of the skill based electronic slot machine. In a similar manner, the gaming module may select entry 205B and access the source file, in this case an image of Michael Jordan who is 6′6″, and utilize that image as a third “reel”, i.e., option, of the skill based electronic slot machine. Specifically, and as will be described in further detail below with reference to FIG. 3, images of Larry Bird and Michael Jordan may be displayed on the client device 110 as optional answers for the skill based question of “Who of the three individuals is the tallest?”

As such, and in this example, the electronic skill based slot machine displays, on client device 110 via gaming application 125, the question of “Who of the three individuals is the tallest?”. Additionally, the electronic skill based slot machine displays, on client device 110 via gaming application 125, three reels where the first reel may be is an image of Paul Pierce, the second reel may be an image of Larry Bird, and the third reel may be an image of Michael Jordan. The participant may then select one of the three displayed images to answer the skill based question. Although reference is made to displaying images, it is expressly contemplated that the one or more embodiments described herein may instead display text, characters, etc. for each of the reels for the electronic skill based slot machine.

The gaming module 126 may generate an additional skill based question, for the electronic skill based slot machine, in a similar manner. For example, the gaming module 126 may generate a skill based question that asks the participant “which of the following contains the most calories?”. The gaming module 126 may, in a similar manner as described above, select entries 205C and 205E, both of which have a classification of calories in the classification field 210C. The gaming module may then display images of an apple and banana for participant selection to answer the skill based question.

FIG. 3 is a diagram illustrating an exemplary skill based electronic slot machine 300 according to the one or more embodiments as described herein. Skill based electronic slot machine 300 may include a skill based question that is to be answered by participant according to the one or more embodiments described herein. The skill based electronic slot machine 300 may be displayed on, for example, client device 110 via gaming application 125. For example, the gaming application 125 that may be installed on client device 110 may store the skill based electronic slot machine 300 or may receive the skill based electronic slot machine 300 from the gaming platform 120 via network 111.

As depicted in FIG. 3, the skill based electronic slot machine 300 may, in an embodiment, include textual portion 305 that includes a text based question for the participant to answer. In this example, the textual portion 305 asks the participants “who of the three individuals is the tallest?”. Additionally, the skill based electronic slot machine 300 may display three different answer options (i.e., reels) 310A, 310B, and 310C on client device 110 that can be selected by the participant utilizing client device 110. Specifically, the gaming module 126 may obtain the three pictures (e.g., 6.jpeg, 1.jpeg, and 2.jpeg) from column 210A that correspond to the height classification in column 210C, and provide the images to the gaming application 125 via network 110 for display on client device 110. In alternative embodiments, the gaming module 126 may display textual data in three different answer options (i.e., reels) 310A, 310B, and 310C on client device 110 that can be selected by the participant utilizing client device 110.

To answer the skill based question that is specified in the textual portion 305 of skill based electronic slot machine 300, the participant may utilize client device 110 to select one of the displayed answer options 310A, 310B, 310C. In this example, answer option 310A is a picture of Paul Pierce who is 6′7″, answer option 310B is a picture of Larry Bird who is 6′9″, and answer option 310C is a picture of Michael Jordan who is 6′6″. Alternatively, the answer option 310A may be text data that recites “Paul Pierce”, answer option 310B may be text data that recites “Larry Bird”, and answer option 310C may be text data that recites “Michael Jordan.”

Based on the selection of one of the three answer options 310A, 310B, and 310C, the gaming module 126 may access the data structure 200 to determine if the selected answer option is the correct or incorrect answer option. For example, if the participant selects answer option 310A that is the picture of Paul Pierce who is 6′7″, the gaming module 126 may access the data structure 200 and determine that the participant has selected an incorrect answer option since the value of 6′7″ in column 210D for entry 205F is not the largest/greatest value of the three values (e.g., 6′7″, 6′9″, and 6′6″) in column 210D corresponding to the height classification in column 210C. Similarly, if the participant selects answer option 310C that is the picture of Michael Jordan who is 6′6″, the gaming module 126 may access the data structure 200 and determine that the participant has selected an incorrect answer since the value of 6′6″ in column 210D for entry 205B is not the largest/greatest value of the three values (e.g., 6′7″, 6′9″, and 6′6″) in column 210D corresponding to the height classification in column 210C.

However, if the participant selects answer option 310B that is a picture of Larry bird who is 6′9″, the gaming module 126 may access the data structure 200 and determine that the participant has selected the correct answer option since the value of 6′9″ in column 210D for entry 205A is the largest/greatest value of the three values (e.g., 6′7″, 6′9″, and 6′6″) in column 210D corresponding to the height classification in column 210C.

The gaming module 126 may generate and display additional skill based questions or tasks as part of a single skill based game for the skill based electronic slot machine 300 (e.g., a single skill based games would require a user to answer a plurality of skill based question where each of the plurality of skill based questions represents a different “spin” of the electronic skill based slot machine 300). For example, a second question may be a question of “which food item has the most calories?” and display an image of an apple, a banana, and a piece of cake that are selectable by the participant to answer the question.

As an example, let it be assumed that the skill based game includes 10 skill based questions. In an embodiment, the participant's score may be determined, by the gaming module 126, based on the number of correctly answered skill based question. In an embodiment, the participant's score may be determined, by the gaming module 126, based on the number of correctly answered based and the time in which the skill based questions are answered.

In an embodiment, one or more normalization techniques may be utilized with the scores determined for a plurality of different participants that may participant in a same type of skill based games having different questions. Because scores computed for different skill based games can be compared based on normalizing the scores, the one or more embodiments described herein provide parity, i.e., a level playing field, to competing participants who may participate in different skill based games for the product/service. That is, and because each participant may answer different questions for the skill based game, the gaming module 126 may utilize one or more different normalization techniques to normalize the score such that one or more winners can be determined from the scores computed for skill based games that include different questions. For example, and in implementation, the following normalization technique may be utilized.

In an embodiment, and during a test phase (e.g., prior to the gaming platform 120 providing the skill based games publicly such that participant can win product/services is offered by merchants), the gaming module 126 may compute a sample average value and a standard deviation value based on N players playing a skill based game X during the testing phase, where the obtain scores are represented as S₁^{X}, S₂^{X}, . . . , S_{N}^{X}. Specifically, the sample average value (μX) and the standard deviation value (σx) may be calculated as:

$$μ X = \frac{1}{N} {\sum }_{n = 1}^{N} {S}_{n}^{X} \\ σ x = \sqrt{\frac{1}{N - 1} {\sum }_{n = 1}^{N} {( {S}_{n}^{X} - μ x )}^{2}} .$$

After calculating the sample average value and standard deviation value in the testing phase, the gaming module 126 can compute a normalized score for participants during a playing phase (e.g., when the gaming platform 120 provides the skill based games publicly such that participants can win products/services offered by merchants). For example, let it be assumed that a new player participates and gets a score of S_{N}^{X} for skill based game X. The gaming module 126 may calculate a normalized score NS^{X} as follows:

$${NS}^{X} = \frac{{S}_{N}^{X} - μ x}{σ x} .$$

As an example, let it be assumed that there are three different skill based games A; B; C and there are 100 players (e.g., N=100). Based on the participation in skill based games A, B, and C, the following scores are received:

{S₁^{A},S₂^{A}, . . . ,S₁₀₀^{A},},{S₁^{B},S₂^{B}, . . . ,S₁₀₀^{B},},{S₁^{C},S₂^{C}, . . . ,S₁₀₀^{C},}.

Using scores, the gaming module 126 computes the following sample average values and standard deviation values for the respective games (A, B, and C):

μA=700; σA=10;

μB=770; σB=15;

μC=840; σC=15,

where μA is the sample average value for game A, σA is the standard deviation value for game A, μB is the sample average value for game B, σB is the standard deviation value for game B, where μC is the sample average value for game C, σC is the standard deviation value for game C.

Now, let it be assumed that new player “Bob” participates in skill based games A, B, and C after the testing phase, and obtains the flowing scores.

S^{A}=680,S^{B}=750,S^{C}=900,

where S^{A} is Bob's score for skill based game A, S^{B} is Bob's score for skill based game B, and S^{C} is Bob's score for skill based game C.

Accordingly, the gaming module 126 may calculate Bob's normalized scores for each of skill based games A, B, and C as follows:

$${NS}^{A} = \frac{680 - 700}{10} = - 2 , {NS}_{B} = \frac{750 - 770}{15} = - \frac{4}{3} , {NS}_{C} = \frac{900 - 840}{15} = 4 ,$$

where NS^{A} is Bob's normalized score for skill based game A, NS^{B} is Bob's normalized score for skill based game B, and NS^{C} is Bob's normalized score for skill based game C

Therefore, even though Bob's score (i.e., raw score) was 20 points below the average score (e.g., sample average value) on both games A and B, since skill game B has a higher standard deviation value (wider range of scores from people who played during the test phase), Bob performed relatively better on skill based game B than on skill based game A.

Although the example described herein utilize a particular algorithm, i.e., technique, to normalize a score obtained from a participant participating in a skill based game, it is expressly contemplated that any of a variety of different techniques and conditional logic may be utilized to normalize a score according to the one or more embodiments described herein. Accordingly, the example as described above for normalizing a score should be taken for illustrative purposes only.

In an embodiment, and instead of normalizing the score, the gaming platform 120 may implement a homogenization technique to provide parity, i.e., a level playing field, to competing participants who may participate in different skill based games for the product/service. Specifically, the gaming module 126 may determine that different questions/tasks have a same level of difficulty. The gaming module 126 may then utilize different questions/task with the same level of determined difficultly across different skill based games such that there is parity, i.e., a level playing field, and scores computed for different skill based games can be compared to determine one or more winners. In an embodiment, the different questions/tasks may have a same level of difficulty that may also correspond to the level of difficultly determined for the participant based on the clustering as described above. For example, if a participant is determined to be at a difficultly level of hard based on the clustering, the questions/tasks that are selected for the participant may also have an assigned difficulty level of hard.

The gaming module 126 may determine a difficulty level (e.g., easy, moderate, difficult, etc.) for a skill based question/task in a variety of different ways. For example, the gaming module 126 may utilize a scoring system with threshold values to determine the difficulty level for a skill based question/task as described herein. As an example, is assume that the skill based question is—“Which one of the following animals is a cheetah?” (i.e., an identifying question not a comparison question), and an electronic skill based slot machine may presents any combination of three different images for user selection. According to the one or more embodiments described herein, the gaming module 126 may determine a difficulty level based on a cumulative score that is calculated from the three images that are presented, and then comparing the cumulative score to one or more threshold values.

Specifically, an authorized user of the gaming platform 120 may first use a ranking scale to define how closely images of animals resemble a cheetah. In an implementation, the ranking scale may be 0, +1, +2, or +3, where 0 is an indication that the image is that of a cheetah and a value of +3 is an indication that the image of the animal does not resemble a cheetah. That is, the assigned number may increase as images of the animals less closely resemble a cheetah. Thus, an image of a cheetah may be assigned a value of 0 by the authorized user, while images of a hyena and a leopard, that closely resemble a cheetah, may be assigned values of +1. Further, an image of a zebra and a monkey may be assigned values of +3 since they do not resemble a cheetah.

The gaming module 126 may then determine a difficulty level for a skill based question/task based on a cumulative score and one or more threshold values. In this example, let it be assumed that the gaming module determines that a skill based question/task is (1) easy if the cumulative score is equal to or greater than +6, (2) moderate if the cumulative score is greater than +2 and less than +6, and (3) hard if the cumulative score is equal to or less than +2.

Continuing with the above example, the gaming module 126 may determine that a is skill based question has a difficulty level of hard if the presented images on the reels include a cheetah (assigned value of 0), a hyena (assigned value of +1), and a leopard (assigned value of +1), since the cumulative score for the three images is +2. However, the gaming module 126 may determine that a skill based question has a difficulty level of easy if the presented images on the reels include a cheetah (assigned value of 0), a zebra (assigned value of +3), and a monkey (assigned value of +3), since the cumulative score for the three images is +6.

With the difficulty level for different skill based questions/tasks determined, the gaming module 126 may generate skill based games having different skill based questions/tasks that have the same difficulty level. Accordingly, scores determined for participants who participate in skill based games, of the same type but having different skill based questions/tasks, can be compared to determine one or more winners. For example, assume that the gaming module 126 generates three different skill based games for three different participants interested in the flat screen TV. Additionally, assume that the gaming module 129 determines the following for each skill based game: questions/tasks 1-3 should be at a difficulty level of “easy”, questions/tasks 4-9 should be at a “difficulty level of “moderate”, and question/task 10 should be at a difficulty of “hard”.

Therefore, the gaming module 126 may utilize different skill based questions/tasks for the three skill based games as long as they have same difficulty level. Because the difficultly level of the skill based questions/tasks are uniform (e.g., the same across the three skill based games), the gaming module 126 can compare the scores determined for the three different participants to determine a winner even though the skill is based questions/tasks may be different. Accordingly, the one or more embodiments described herein provide parity, i.e., a level playing field, to competing participants who may answer/perform different skill based questions/tasks.

Although the example of “Which one of the following animals is a cheetah?” is an identifying question, it is expressly contemplated that the homogenization technique may be utilized with a comparison question/task. For example, and as described above, a difficulty level may be determined based on range values associated with the images presented, e.g., height differences between Paul Pierce, Larry Bird, and Michael Jordan. The determined difficulty level for the comparison questions/tasks may be utilized, as described herein, as part of different skill based games to provide parity and compare scores determined for competing participants who do not answer/perform the same skill based questions/tasks.

Alternatively, and during a testing phase, the gaming module 126 may determine that if a threshold number of testing participants get the question correct or are able to perform the task correctly then the question/task is classified/determined as being hard in terms of difficult. If a different (i.e., greater) number of testing participants gets the question correct or are able to perform the task correctly then the question/task is classified/determined as being moderate in terms of difficulty. If a different (i.e., even greater number of testing participants get the question correct or are able to perform the task correctly then the question/task is classified/determined as being easy in terms of difficulty.

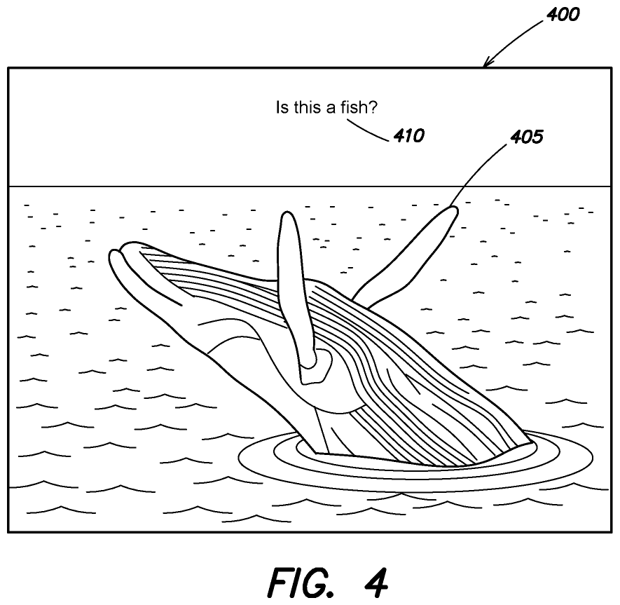

FIG. 4 is a diagram illustrating an exemplary different skill based electronic game 400 according to the one or more embodiments as described herein. Instead of displaying is three different answer options as illustrated in FIG. 3, the skill based electronic game 400 only displays a single image answer 405 that relates to textual portion 410. In this example, the textual portion 410 ask the participants “Is this a fish?” with the single image answer option 405 displaying a whale. The gaming module 126 may obtain the picture of the whale from a data structure in a similar manner as described above with reference to FIG. 3.

To answer the skill based question that is specified in textual portion 410, the participant may utilize client device 110 to either answer “yes” or “no”. In the example of FIG. 4, the skill based question is a binary question, e.g., has either an answer of yes or no. In the example of FIG. 4, the user may answer “yes” by swiping right on the display screen of the client device 110. The user may answer “no” by swiping left on the display screen of the client device 110. Alternatively, the client device 110 may display graphical affordances for “yes” and “no”, and the participant may select one of the graphical affordances using client device 110.

The gaming module 126 may access data structure 200 (or a similar data structure) in a similar manner as described above with reference to FIG. 3, to determine if the answer provided by the participant is the correct or incorrect answer. The gaming module 126 may generate and display additional skill based questions/tasks, that are similar to those as describe herein, to the participants. The gaming module 126 may generate an overall score for each participant to determine a winner in a manner as described herein. In an embodiment, the determined winner who purchased one or more electronic entries may receive (e.g., a prize) the product/service offered by the merchant.

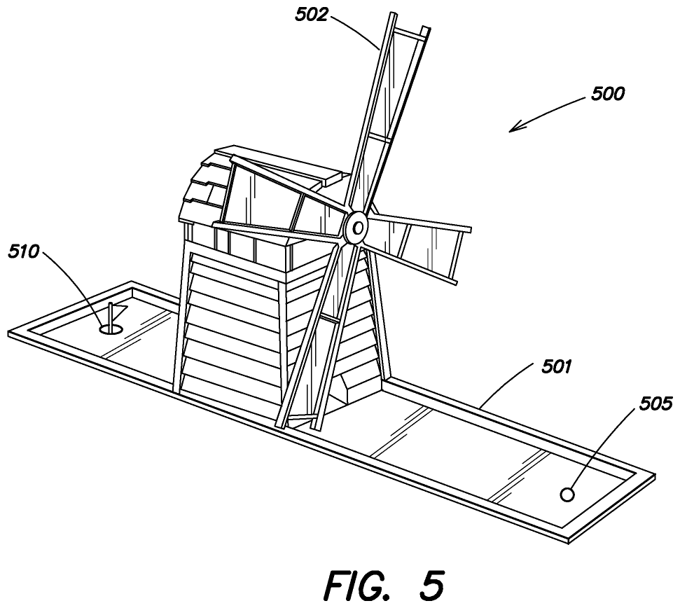

FIG. 5 is a diagram illustrating an exemplary skill based task 500 according to the one or more embodiments as described herein. The skill based task 500 of FIG. 5 is a putting contest that includes putting green 501 with obstacle 502 that in this example is a windmill. Specifically, the skill based task 500 requires that participants use client device 110 to strike ball 505 into in cup 510 in the least amount of strokes.

The gaming module 126 may access a data structure, similar to that as described with reference to FIG. 2, to select particular putting greens (e.g., different shape, sizes, elevations, locations of cup, etc.) and different obstacles (e.g., windmill, rocks, etc.) that can alter the difficulty level of the putting contest for different participants. As such, different putting greens can be generated by gaming module 126 for different skilled participants in a similar manner as described above. In this example, the winner may be the participant who utilizes the least amount of strokes to hit ball 505 in cup 510. Alternatively, there may be a plurality of winners. For example, the three participants who utilized the least amount of strokes of all participants may be the three determined winners.

In an embodiment, there may be a plurality of holes that make up the putting contest and the determined winner may the participant with the least amount of strokes to complete the plurality of holes. The gaming module 126 may generate an overall score for each participant to determine one or more in manner as described herein. In an embodiment, the determined one or more winner who purchased one or more electronic entries may receive (e.g., a prize) the product/service offered by the merchant.

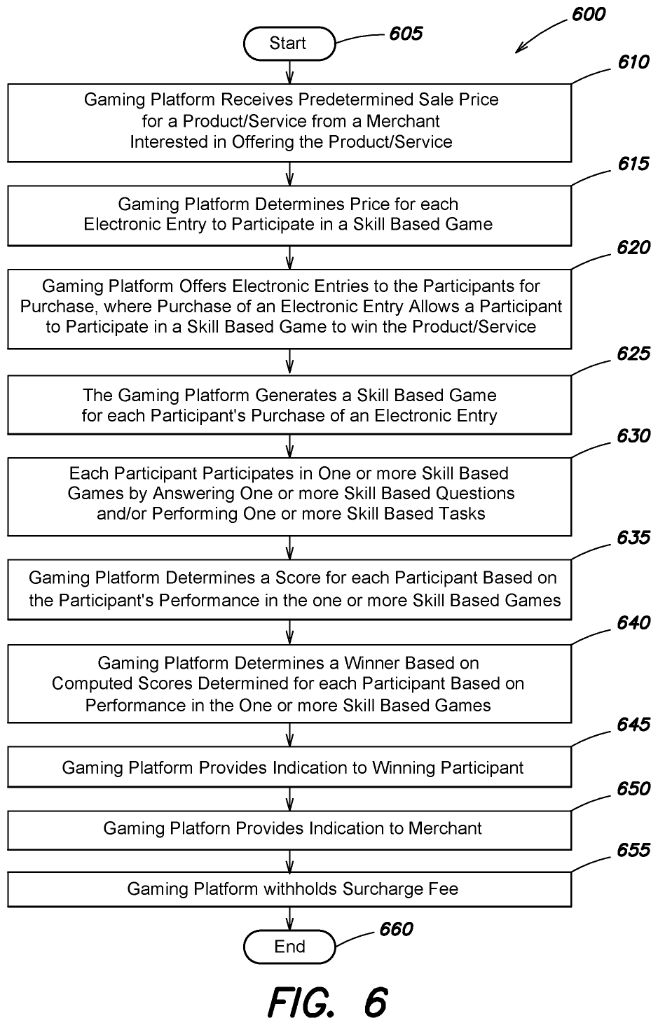

FIG. 6 is an example flow diagram illustrating a series of steps that may be performed according to the one or more embodiments described herein. The procedure 600 starts at step 605 and continues to step 610 where the gaming platform 120 receives a predetermine sale price for a product/service from a merchant interested in offering the product/service. Specifically, the merchant may utilize the gaming application 125, executing on a client device 110, to input a predetermine sale price for the product/service. Alternatively, the predetermine sale price may be predefined or may be determined in any of a variety of different ways. For example, artificial intelligence may evaluate the characteristics of the product/service to determine a fair market price for the product/service. In this example, let it be assumed that the merchant utilizing the gaming application 125 to indicate that the predetermined sale price for a flat screen TV is $1000.

The predetermined sale price may then be provided over the network 111 to the gaming platform 120. Although the example as described herein may refer to a flat screen TV, it is expressly contemplated that the one or more embodiments described herein may be utilized with any product/service that may be offered by a merchant at a predetermined sale price. For example, a merchant may offer a non-fungible token (NFT) for a predetermined sale price. As another example, a merchant may offer a digital reward such as badges, tokens, coins, etc.

The procedure continues to step 615 and the gaming platform 120 determines a price for each electronic entry to participate in a skill based game. In an implementation, each purchased electronic entry allows the participant to participate in a skill based game as described herein.

For example, the gaming module 126 may determine an electronic entry fee for participating in a skill based game to win the product/service based on the predetermined sale price provided by the merchant. In an implementation, the gaming module 126 may determine the electronic entry free in any of a variety of different ways. For example, the electronic entry free may be a percentage, e.g., a fractional percentage, of the predetermined sale price. In this example, let it be assumed that the gamine module 126 determines that each electronic entry fee should be 5% of the predetermined sale price. As such, and in this example, each electronic entry to participate in a skill based game to win the flat screen TV is $50 (e.g., 5% of $1000).

In an implementation, the total number of entries to be sold to participants may be based on the individual electronic entry fee and the predetermined sale price for the product/service that is set by the merchant. In this example, and since each electronic entry is $50, a total of 20 electronic entries have to be sold such that the predetermined sale price of $1000 is obtained. As such, and according to the one or more embodiments described herein, 20 electronic entries may be sold at $50 dollars apiece so that the merchant's predetermined sale price of $1000 is met. Therefore, and in this example, the participant that is determined to be the winner can win the flat screen TV for the cost of the total number of electronic entries purchased by the winning participant (e.g., a cost of $50 dollars if the winning participant purchased a single electronic entry). Additionally, the merchant can receive the $1000, which is the predetermined sale price set by the merchant, based on proceeds received from selling the 20 electronic entries to the participants.

In a different embodiment, the total number of electronic entries to be sold to participants may be based on the individual electronic entry fee, the predetermined sale price for the product/service that is set by the merchant, and an additional surcharge amount. Continuing with the example of the flat screen TV, let it be assumed that the is surcharge fee is $200 and the surcharge fee is provided to the gaming platform 120 for generating and managing the electronic skill based games. As such, the total cost that includes the predetermined sale price plus the surcharge fee is $1200. Therefore, and based on each electronic entry being $50, a total of 24 electronic entries have to be sold such that the predetermined sale price plus surcharge fee of $1200 is obtained.

Therefore, and in this example, the participant that is determined to be the winner can win the flat screen TV that is $1000 for the cost of the total number of electronic entries purchased by the winning participant (e.g., a cost of $50 dollars if the winning participant purchased a single electronic entry). Additionally, the merchant can receive the $1000 and the gaming platform 120 may receive $200 (for managing and generating the skill based games) based on the sale of the 24 electronic entries to the participants.

Alternatively, 20 electronic entries can be sold at $60 apiece, and the merchant can receive $1000 and the gaming platform 120 may receive $200. For this example, let it be assumed that 24 electronic entries, each sold at $50, are sold to participants who are interested in winning the flat screen TV that the merchant has valued at $1000. In this example, the $1000 that is obtained from sale of the 24 electronic entries will go to the merchant while $200 will go to the gaming platform 120.

The procedure continues to step 620 and the gaming platform 120 offers the electronic entries to the participants for purchase, where the purchase of an electronic entry allows a participant to participate in a skill based game to win the product/service. For example, the gaming application 125 executing on the client device may provide one or more user interfaces that allow a participant to select and purchase one or more electronic entries for the flat screen TV that has a predetermined sale price of $1000.

The procedure continues to step 625 where the gaming platform generates a skill based games for each participant's purchase of an electronic entry. In an implementation, the number of the generated games equals the number of electronic entries purchased by the participants. In an embodiment, the gaming module 126 may generate each of the skill based questions/tasks for each of the skill based games on-demand and just prior to display of the skill based question/task on the client device 110 via gaming application 125. That is, the skill based games that include the skill based questions/tasks do not have to pre-generated and stored in, for example, storage.

The gaming module 126 may generate one or more skill based questions/tasks for each skill based game, and each skill based game may be presented as an electronic skill based slot machine 300 as described above with relation to FIGS. 2-5. In an embodiment, the gaming module 126 may determine a difficultly level for each participant utilizing a clustering algorithm as described herein. The gaming module 126 may generate, for a participant, one or more skill based questions/tasks that have a level of difficulty that matches the determined difficulty level for the participant.

In an embodiment, the gaming module 126 may utilize the homogenization technique, as described herein, to generate/select the skill based question for the skill based games to provide parity among competing participants who answer/perform different skill based questions/tasks. The skill based questions/tasks of the electronic skill based slot machine 300 may be provided via gaming application 125 of client device 110 such that the participants can answer/perform each of the skill based questions/tasks to complete performance of the skill based game. In this example, let it be assumed that the skill based game includes 10 skill based question that the participants are to answer.

The procedure continues to step 630 and each participant participates in one or more skill based games by answers one or more skill based questions and/or performing one or more skill based tasks. In an embodiment, a participant participates in a number of skill based games that is equal to the number of electronic entries purchased by the participant. In an implementation, the participants may utilize one or more user interfaces on the client device 110 to answer the skill based questions and/or perform the skill based tasks via gaming application 125. Thus, and in this example, each participant may utilize the client device 110 to answer the 10 skill based questions to complete participation in the skill based game.

In an embodiment, the difficulty level determined for a participant and/or the participant's success answering skill based questions or performing skill based tasks may be used by the gaming module 126 to identify one or more topics or subject matters of interest to the participant. For example, let it be assumed that Johnny Mixes participates in a skilled based game that includes 5 expert questions related to sports and 5 easy questions related to art history. Further, let it be assumed that Johnny Mixes answers all 5 expert level sports related questions correctly and answers only 2 easy level art history related questions correctly.

The gaming module 126 may determine that sports is a topic of interest to Johnny because (1) he is at an expert level with relation to sports based questions, or (2) he answered at least 50% of the expert level sports related questions. Based on determining that the topic or subject matter is of interest to the participant, the gaming module 126 is may provide targeted advertising to the client device 110 operated by Johnny. Specifically, the gaming module 126 may transmit and display advertisements related to sports on the client device 110 operated by Johnny. For example, the advertisements may be for the sale of sports memorabilia, sale of sporting event tickets, athletic coaching, etc.

As another example, the gaming module 126 may determine that Johnny has interest in sports if he participates in a certain number of skill based games where the product or service to be won is related to sports (e.g., a signed baseball glove). As such, the gaming module 126 may provide sports advertising to the client device 110 operated by Johnny based on a determination that he has participated in a threshold number of skill based games where the product/service to be won is related to sports.

Therefore, any of a variety of different criteria related to the participant and/or the skill based games, that the participant participates in, may be utilized to determine what type of advertisements should be targeted to the participant. In an embodiment, the data regarding the topic or subject matter of interest may be provided to one or more advertising entities/corporations. For example, and in response to determining the topic or subject matter of interest for the participant by the gaming module 126, the gaming platform 120 may provide (e.g., sell) the data and participant metadata (e.g., email address, IP address, phone number, etc.) to one or more advertising entities/companies that may utilize the data and participant metadata to send targeted advertisements to the participant. In an embodiment, a participant must agree to allow the gaming platform 120 to provide the data and participant metadata to the one or more advertising entities/companies. For example, a message may appear within the application 125 executing on the client device 110, operated by the participant, asking the participant if he/she agrees to allow the gaming platform 120 to use/provide the data and participant metadata. The participant may utilize the client device 110 to either agree or disagree.

The procedure continues to step 635 and the gaming platform 120 determines a score for each participant based on the participant's performance in the one or more skill based games. For example, the gaming module 126 may utilized any of a variety of different algorithms and conditional logic to determine the participant's score, where the algorithm and conditional logic may utilize the number correct answers provided for the 10 skill based questions and/or the amount of time it takes the participant to answer the 10 skill based questions. For example, a participant may be given a score of 7/10 if the participant answered 7 of the skill based questions correctly and answered 3 of the skill based questions incorrectly.

In an implementation, the participant's score may be normalized by the gaming module 126 as described herein. By normalizing computed scores, the scores can be compared to determine a winner even though the scores are computed for different skill based games, e.g., a plurality of skill based games that are the same type but each of which may include different questions/tasks. In this example, the gaming module 126 may normalize the 24 different scores computed for the 24 different skill based games such that the 24 scores can be compared even though the 24 skill based games may have different questions/tasks.

The procedure continues to step 640 and the gaming platform 120 determines one or more winners based on the computed scores determined for each participant based on performance in the one or more skill based games. Thus, and in this example, the gaming module 126 may compare the 24 different scores to determine a single winner. In an embodiment, and when there are multiple participants who have the same winning score, e.g., a plurality of participants have the same winning score, the gaming module 126 may iteratively generate an additional skill based game, as described above with reference to FIGS. 2 and 3, until a single winner is determined. For example, if the gaming module determines that 3 participants have the highest score, the gaming module 126 may generate an additional skill based game for the 3 participants. If the 3 participants participate in the additional skill based and 2 participants have the highest score for the additional skill based game, the gaming module 126 may generate a third additional skill based game for the 2 participants. Further additional skill based games may be generated until single high score is determined. Alternatively, there may be multiple winners. For example, let it be assumed that the product to be won is money (e.g., US dollars) or an NFT. In this alternative example, a plurality of determined winners may split the product. For example, if the product is $1000 dollars, the $1000 may be divided, in any of a variety of different ways, between a plurality of determined winning participants, e.g., 3 participants.

In an embodiment, the gaming module 126 may generate one or more dynamic electronic leaderboards to rank a plurality of selected participants. In an embodiment, gaming module 126 may generate a dynamic electronic leaderboard for a particular participant such that the particular participant has a at least a specific ranking (e.g., baseline ranking) in relation to all ranked participants that are included in the generated dynamic electronic leaderboard.

For example, let it be assumed that the gaming module 126 is generating a is dynamic electronic leaderboard for participant Mark Fox, who is a 35 year old accountant living in New York City. Further, and for this example, let it be assumed that the baseline ranking is set as a top 15% ranking. As such, Mark Fox is to be ranked in the top 15% of all participants that are ranked in the dynamic electronic leaderboard that is generated for Mark Fox. Although the baseline ranking of this example is a top 15% ranking, it is expressly contemplated that any of a variety of different baseline ranking values, ranges of values, thresholds, etc., may be used to generate a dynamic electronic leaderboard according to the one or more embodiments as described herein.

Continuing with the Example, let it be assumed that Mark participated in two skill based games on the current day. In the first skill based game, Mark got 7 of 10 total questions correct. For the second skill based game, Mark got 12 of 20 total questions correct. Therefore, and in the aggregate, Mark got 15 of 30 total questions correct for the day. As such, Mark's aggregate percent score is 50% for the day.

The gaming module 126 may generate one or more dynamic electronic leaderboards for Mark Fox where he has a top 15% ranking for all participants that are ranked in the dynamic electronic leaderboard. For example, the gaming module 126 may identify one or more characteristics that are shared between Mark and a plurality of other participants. In this example, let it be assumed that the gaming module 126 utilizes the following three characteristics— (1) Male, (2) lives in New York City, and (3) accounting professional.

The gaming module may identify a plurality of other participants who share all three characteristics. Of the identified participants who share all three characteristics, the is gaming module 126 may select particular participants who have scores such that Mark's scores falls in the top 15% of all scores. For example, the gaming module 126 may select (1) 90 other participants that share the three characteristics and have a an aggregate percentage score for the day that is less than Mark's score of 50%, and (2) 9 other participants that share the three characteristics and have an aggregate percentage score for the day that is greater than Mark's score of 50%. Therefore, and in this example, Mark would have the 10^{th} best score and would be in the top 10% of all scores.

As another example, the gaming module 126 may select (1) 35 other participants that share the three characteristics and have a an aggregate percentage score for the day that is less than Mark's score of 50%, and (2) 4 other participants that share the three characteristics and have an aggregate percentage score for the day that is greater than Mark's score of 50%. Therefore, and in this example, Mark would have the 5^{th} best score and would be in the top 12.5% of all scores.

The gaming module 126 may modify the criteria to generate additional different leaderboards for Mark such that he's in the top 15% of all scores. For example, the gaming module 126 may generate an dynamic electronic leaderboard in a similar manner as described above but using additional (Male, lives in New York City, accounting profession, and older than 30 years of age), less (Male living in New York City), and/or different characteristics (has facial hair and is over 6 feet tall). In an embodiment, it is expressly contemplated that if the baseline score cannot be achieved for the participant based on the selected characteristics, the characteristics may be modified.

The one or more generated dynamic electronic leaderboards may be displayed on the client device of the participant for which the leaderboards are generated. In this example, let it be assumed that two dynamic electronic leaderboards are generated for Mark such that he is in the top 15% of ranked participants on both leaderboards. The two leaderboards may be displayed on Mark's client device 110. By generating the dynamic electronic leaderboards according to the one or more embodiments as described herein, participants are encouraged to participate in more skill based games to maintain their ranking. For example, and according to the one or more embodiments as described herein, the participant may receive a prize, money, NFT, one or more electronic entries for other skill based games, or any of a variety of different products or services if the participant maintains or improves his ranking on the generated dynamic electronic leaderboards.

For example, the gaming platform 120 may display the two generated dynamic electronic leaderboards on Mark's client device 110 with a message that states—“If you stay in the top 15% on both leaderboards, you will win 10 electronic entries to a skill based game to win a car worth $12,000”. As such, Mark is encouraged to participate in more skill based games such that his ranking is maintained or improves, which in turn provides him the opportunity to win the car.

With certain conventional systems, one or more non-dynamic, i.e., static, leaderboards are generated based on only the scores of the participants. Such non-dynamic leaderboards can have thousands of ranked participants. As such, the data representing the leaderboard that tracks the rankings can become vast and consume a large amount of storage resources (e.g., cloud computing storage) that may store the leaderboard that is accessible by all participants. In contrast, the dynamic electronic leaderboard as described herein is dynamically generated for each specific participant.

As such, the dynamic electronic leaderboard as described herein can have much fewer participants when compared to conventional systems. Specifically, the dynamic electronic leaderboard can have a minimum number of participants such that the participant ranking on the leaderboard complies with the baseline ranking. Therefore, the dynamic electronic leaderboard does not have to be stored at a central location, and can be pushed and stored locally on the client device of the participant for which the leaderboard was generated. As such, the dynamic electronic leaderboard conserves storage resources (e.g., cloud computing storage) when compared to certain conventional systems.

The procedure continues to step 645 and the gaming platform 120 provides an indication to the winning participant. For example, the gaming module 126 may provide a message over network 111 to the gaming application 125 on the client device 110. The gaming application may display, on the client device 110, the message or indication to the winning participant that he/she won the flat screen TV based on having the highest score for a skill based game. The gaming module 126 may then confirm, for example, to the winning participant that the flat screen TV is being processed for shipping to the winning participant's address.

The procedure continues to step 650 and the gaming platform 120 provides an indication to the merchant. For example, the merchant may operate a client device 110 and the gaming application 125 executing on the client device 110 of the merchant may display a message or indication to the merchant that his flat screen TV has sold and that is the merchant will be receiving the $1000. The gaming module 126 may initiate a transfer of the $1000 to the account, e.g., banking account, of the merchant.

The procedure continues to step 655 and the gaming platform 120 withholds a surcharge fee. For example, the gaming module 126 may initiate the transfer of $200 to an account, a banking account, associated with the gaming platform 120. The procedure may end at step 460.

The foregoing description of embodiments is intended to provide illustration and description, but is not intended to be exhaustive or to limit the disclosure to the precise form disclosed. Modifications and variations are possible in light of the above teachings or may be acquired from a practice of the disclosure. For example, while a series of acts has been described above with respect to the flow diagram, the order of the acts may be modified in other implementations. In addition, the acts, operations, and steps may be performed by additional or other modules or entities, which may be combined or separated to form other modules or entities. Further, non-dependent acts, operations, and steps may be performed in parallel. Also, the term “user”/“participant”, as used herein, is intended to be broadly interpreted to include, for example, a computer or data processing system (e.g., system 2000) or a human user of a computer or data processing system, unless otherwise stated. Additionally, Appendix A and Appendix B include different implementations of the one or more embodiments described herein that may include, but are not limited to, types of skill based questions, types of skill based tasks, advantageous of the one or more embodiments described herein, different mechanics that can be utilized for the skill based game according to the one or more embodiments described herein, etc. Further, Appendix C provides a summary of one or more different implementations as described herein.

What is claimed is:

1. A gaming platform, comprising:
a processor coupled to a memory, the processor when executed configured to:
receive a predetermined sale price for a product or service offered by a merchant;
determine a purchase price for each of a plurality of electronic entries wherein the purchase price is based on the predetermined sale price, and wherein the plurality of electronic entries are purchasable by at least two participants to participate in an electronic skill based game to win the product or service;
in response to determining that a threshold number of the plurality of electronic entries are purchased by the at least two participants, generate, on-demand, the electronic skill based game for each the of the at least two participants, wherein when performing the generating the processor further configured to:
select (1) a plurality of skill based questions to be answered by at least two participants or (2) select a plurality of skill based tasks to be performed by the at least two participants,
wherein the selecting is performed utilizing a homogenization technique to generate at least two electronic skill based games that includes the plurality of skill based questions or the plurality of skill based tasks, and wherein the at least two electronic skill based games for the at least two participants are different based on the utilization of the homogenization technique;
where a determined answer to each skill based question and each skill based task is predominately based on skill and not predominately based on chance;
determine a score for each of the at least two participants based on at least a number of the plurality of skill based questions answered correctly by the at least two participants or a number of the plurality of skill based tasks performed correctly by the at least two participants; and
determine one or more winning participants based on a comparison of the scores.

2. The gaming platform of claim 1, wherein each of electronic skill based games generated for the at least two participants is a same type and includes a plurality of different skill based questions or a plurality of different skill based tasks that are determined to be a same difficulty.

3. The gaming platform of claim 2, wherein the process is further configured to normalize each of the scores determined for the at least two participants utilizing one or more different normalization techniques to perform the comparison of scores.

4. The gaming platform of claim 3, wherein when normalizing a score of a particular participant, the processor further configured to:
determine an average value and a standard deviation value for a particular skill based game based on a plurality of previous participants scores obtained during a testing phase; and
utilize the score of the particular participant with the average value and the standard deviation value to generate a normalized score for the particular participant.

5. The gaming platform of claim 1, wherein each of the electronic skill based games generated for the at least two participants is an electronic skill based slot machine that includes a plurality of reels, where each reel is selectable by the participant.

6. The gaming platform of claim 1, wherein a particular skill based game includes one or more binary questions.

7. The gaming platform of claim 6, wherein the processor is further configured to:
receive an indication, via a client device, a particular answer of yes or no for each of the one or more binary questions.

8. A method for generating an electronic skill based game, the method comprising:
receiving, at a gaming platform, a predetermined sale price for a product or service offered;
determining, by a processor of the gaming platform, a purchase price for each of a plurality of electronic entries wherein the purchase price is based on the predetermined sale price, and wherein the plurality of electronic entries are purchasable by at least two participants to participate in the electronic skill based game to win the product or service offered;
in response to determining that a threshold number of the plurality of electronic entries are purchased by of the at least two participants, generate, on-demand, the electronic skill based game for each the at least two participants, wherein generating the electronic skill based game comprises:
generating, utilizing a clustering algorithm, a plurality of cluster each of which includes a plurality of cluster participants that share cluster participant metadata;
analyzing the cluster participant metadata of each of the plurality of clusters to determine a cluster skill level for each of the plurality of clusters;
generating a cluster profile for each of the clusters, wherein the cluster profile includes information based on the cluster participant metadata and the determined cluster skill level;
comparing participant metadata for each of the at least two participants to the cluster profile determined for each of the plurality of clusters;
in response to performing the comparison, identifying a particular cluster of the plurality of clusters for each of the at least two participants;
assigning, to each of the at least two participants, a particular difficulty level that corresponds to the cluster skill level of a particular cluster profile of the identified particular cluster; and
selecting (1) a plurality of skill based questions to be answered by the at least two participants or (2) selecting a plurality of skill based tasks to be performed by the at least two participants, wherein the selected skill based questions or selected skill based tasks have a determined difficulty that corresponds to the particular difficulty level,
where a determined answer to each skill based question and each skill based task is predominately based on skill and not predominately based on chance;
determining a score for each of the at least two participants based on at least a number of the plurality of skill based questions answered correctly by the at least two participants or a number of the plurality of skill based tasks performed correctly by the at least two participant; and
determining one or more winning participants based on a comparison of the scores determined for the at least two participants.

9. The method of claim 8, wherein each of electronic skill based games generated for the at least two participants is a same type and includes a plurality of different skill based questions or a plurality of different skill based tasks that are determined to be a same difficulty.

10. The method of claim 8, further comprising normalizing each of the scores determined for the at least two participants utilizing one or more different normalization techniques to perform the comparison of scores.

11. The method of claim 10, wherein when normalizing a score of a particular participant, the method further comprising:
determining an average value and a standard deviation value for a particular skill based game based on a plurality of previous selected participants scores obtained during a testing phase; and
utilizing the score of the particular participant with the average value and the standard deviation value to generate a normalized score for the particular participant.

12. The method of claim 8, wherein each of the electronic skill based games generated for the at least two participants is an electronic skill based slot machine that includes a plurality of reels, where each reel is selectable by the participant.

13. The method of claim 8, further comprising:
identify one or more first attributes of a particular participant or one or more second attributes of a particular skill based game that the particular participant participated in;
determining a topic of interest of the particular participant that corresponds to the one or more first attributes or the one or more second attributes; and
displaying one or more advertisements, related to the topic of interest, on a particular computing device operated by the particular participant.

14. The method of claim 8, wherein a particular skill based game includes one or more binary questions, the method further comprising:
receiving an indication, via a client device, a particular answer of yes or no for each of the one or more binary questions.

15. One or more non-transitory computer-readable media, having stored thereon instructions that when executed by a computing device, cause the computing device to perform operations comprising:
receiving a predetermined sale price for a product or service offered;
determining a purchase price for each of a plurality of electronic entries wherein the purchase price is based on the predetermined sale price, and wherein the plurality of electronic entries are purchasable by at least two participants to participate in the electronic skill based game to win the product or service offered;
in response to determining that a threshold number of the plurality of electronic entries are purchased by of the at least two participants, generate, on-demand, the electronic skill based game for each the at least two participants, wherein generating the electronic skill based game comprises:
generating, utilizing a clustering algorithm, a plurality of cluster each of which includes a plurality of cluster participants that share cluster participant metadata;
analyzing the cluster participant metadata of each of the plurality of clusters to determine a cluster skill level for each of the plurality of clusters;
generating a cluster profile for each of the clusters, wherein the cluster profile includes information based on the cluster participant metadata and the determined cluster skill level;
comparing participant metadata for each of the at least two participants to the cluster profile determined for each of the plurality of clusters;
in response to performing the comparison, identifying a particular cluster of the plurality of clusters for each of the at least two participants;
assigning, to each of the at least two participants, a particular difficulty level that corresponds to the cluster skill level of a particular cluster profile of the identified particular cluster; and
selecting (1) a plurality of skill based questions to be answered by the at least two participants or (2) selecting a plurality of skill based tasks to be performed by the at least two participants, wherein the selected skill based questions or selected skill based tasks have a determined difficulty that corresponds to the particular difficulty level,
where a determined answer to each skill based question and each skill based task is predominately based on skill and not predominately based on chance;
determining a score for each of the at least two participants based on at least a number of the plurality of skill based questions answered correctly by the at least two participants or a number of the plurality of skill based tasks performed correctly by the at least two participant; and
determining one or more winning participants based on a comparison of the scores determined for the at least two participants.

16. The non-transitory computer-readable media of claim 15, wherein each of electronic skill based games generated for the at least two participants is a same type and includes a plurality of different skill based questions or a plurality of different skill based tasks that are determined to be a same difficulty.

17. The non-transitory computer-readable media of claim 15, wherein the instruction further cause the computing device to perform operations comprising normalizing each of the scores determined for the at least two participants utilizing one or more different normalization techniques to perform the comparison of scores

18. The non-transitory computer-readable media of claim 15, when normalizing a score of a particular participant, the computing device further performing operations comprising:
determining an average value and a standard deviation value for a particular skill based game based on a plurality of previous participants scores obtained during a testing phase; and
utilizing the score of the particular participant with the average value and the standard deviation value to generate a normalized score for the particular participant.

19. The non-transitory computer-readable media of claim 15, wherein each of the electronic skill based games generated for the at least two participants is an electronic skill based slot machine that includes a plurality of reels, where each reel is selectable by the participant.

20. The non-transitory computer-readable media of claim 15, wherein a particular skill based game includes one or more binary questions.

21. The non-transitory computer-readable media of claim 15, the computing device further performing operations comprising:
identifying a selected participant who has participated in one or more particular skilled based games over a predetermined time period;
determining an aggregate score the selected participant based on participation in the one or more particular skilled based games, wherein the aggregate score is utilized to determine a ranking for the participant;
selecting one or more characteristics that are shared between the selected participant and one or more other participants, wherein the selecting is based on a determination that the ranking for the selected participant, in relation to other rankings of the one or more other participants, is equal to or better than a baseline ranking; and
generating a dynamic leaderboard that ranks the selected participant with the plurality of other participants based on the raking and the other rankings, wherein the dynamic leaderboard graphical or textually displays the ranking of the selected participant being equal to or better than the baseline ranking.
